(19) United States
(12) Patent Application Publication
(10) Pub. No.: US 2012/0013248 A1
(43) Pub. Date: Jan. 19, 2012

(54) PLASMA DISPLAY PANEL

(76) Inventors: Kyohei Yoshino, Osaka (JP); Takuji Tsujita, Osaka (JP); Takehiro Zukawa, Osaka (JP); Keiji Horikawa, Osaka (JP)

(21) Appl. No.: 13/148,129

(22) PCT Filed: Feb. 24, 2011
(86) PCT No.: PCT/JP2011/001049

§ 371 Date: Oct. 3, 2011

(30) Foreign Application Priority Data
Mar. 1, 2010 (JP) 2010-043914

(51) Int. Cl. H01J 17/49

(52) U.S. Cl. 313/587

(57) ABSTRACT

A PDP has a front plate and a rear plate. The front plate includes a protective layer, and the rear plate includes phosphor layers. The protective layer includes a base layer. Agglomerated particles are dispersed on the base layer. The base layer includes a first metallic oxide and a second metallic oxide. The base layer has a peak through an X-ray diffraction analysis between a first peak of the first metallic oxide and a second peak of the second metallic oxide. The first metallic oxide and the second metallic oxide are two selected from a group consisting of MgO, CaO, SrO, and BaO. The phosphor layers include particles of a platinum group element.

### TECHNICAL FIELD

The technology disclosed herein relates to a plasma display panel used in, for example, a display device.

### BACKGROUND ART

A plasma display panel (hereinafter, called PDP) has a front plate and a rear plate. The front plate includes a glass substrate, display electrodes formed on a main surface of the glass substrate, a dielectric layer covering the display electrodes to function as a capacitor, and a protective layer made of magnesium oxide (MgO) formed on the dielectric layer. Meanwhile, the rear plate includes a glass substrate, data electrodes formed on a main surface of the glass substrate, a base dielectric layer covering the data electrodes, barrier ribs formed on the base dielectric layer, and phosphor layers respectively formed between the barrier ribs to emit red, green, and blue light.

The front plate and the rear plate are air-tightly sealed to each other with their electrode-formed surfaces facing each other. A discharge gas containing neon (Ne) and xenon (Xe) is enclosed in a discharge space divided by the barrier ribs. The discharge gas is electrically discharged by a video signal voltage selectively applied to the display electrodes. The electric discharge generates ultraviolet light, and the generated ultraviolet light excites the phosphor layers. The excited phosphor layers respectively emit the red, green, and blue light. This is the mechanism of a color image display in PDP (see Patent Document 1).

There are four main functions exerted by the protective layer; 1) protect the dielectric layer from the impact of ions through the electric discharge, 2) release primary electrons to cause data discharge, 3) retain charges for causing the electric discharge, and 4) release secondary electrons during sustain discharge. Because the dielectric layer is protected from the ion-induced impact, a discharge voltage is prevented from increasing. As more primary electrons are released, a data discharge error, which is a factor responsible for flickering images, is reduced. Improvement of a charge retainability reduces the voltage to be applied, and it reduces a sustain discharge voltage to release more secondary electrons. An attempt for increasing the primary electrons to be released is to add, for example, silicon (Si) or aluminum (Al) to MgO of the protective layer (for example, see Patent Documents 1, 2, 3, 4, and 5).

### PRIOR ART DOCUMENTS

### Patent Documents

Patent Document 1: Unexamined Japanese Patent Publication No. 2002-260535
Patent Document 2: Unexamined Japanese Patent Publication No. 11-339665
Patent Document 3: Unexamined Japanese Patent Publication No. 2006-59779
Patent Document 4: Unexamined Japanese Patent Publication No. 08-236028
Patent Document 5: Unexamined Japanese Patent Publication No. 10-334809

### DISCLOSURE OF THE INVENTION

A PDP has a front plate and a rear plate disposed so as to face the front plate. The front plate includes a dielectric layer and a protective layer which covers the dielectric layer. The rear plate includes a base dielectric layer, a plurality of barrier ribs formed on the base dielectric layer, and phosphor layers formed on the base dielectric layer and side surfaces of the barrier ribs. The protective layer includes a base layer formed on the dielectric layer. Agglomerated particles in which crystal particles of magnesium oxide are agglomerated to one another are dispersed evenly on an entire surface of the base layer. The base layer includes at least a first metallic oxide and a second metallic oxide. The base layer has at least a peak through an X-ray diffraction analysis. The peak is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of the base layer. The first metallic oxide and the second metallic oxide are two selected from a group consisting of magnesium oxide, calcium oxide, strontium oxide, and barium oxide. The phosphor layers include particles of a platinum group element.

### BRIEF DESCRIPTION OF THE DRAWINGS

FIG. 1 is a perspective view illustrating a structure of PDP according to an embodiment.

FIG. 2 is a sectional view illustrating a structure of a front plate in the PDP.

FIG. 3 is a graph illustrating X-ray diffraction analysis results obtained from a surface of a base film in the PDP.

FIG. 4 is a graph illustrating X-ray diffraction analysis results obtained from a surface of another base film in the PDP.

FIG. 5 is an enlarged view illustrated to describe agglomerated particles according to the embodiment.

FIG. 6 is a graph illustrating a relationship between a discharge delay and a calcium (Ca) concentration in a protective layer in the PDP according to the embodiment.

FIG. 7 is a characteristic graph illustrating a study result on an electron releasability and a Vscn lighting voltage in the PDP.

FIG. 8 is a characteristic graph illustrating a relationship between the electron releasability and an average particle diameter of the agglomerated particles according to the embodiment.

FIG. 9 is flow chart illustrating protective layer formation steps according to the embodiment.

FIG. 10 is a sectional view illustrating the structure of the PDP.

FIG. 11 is a flow chart illustrating phosphor layer formation steps according to the embodiment.

FIG. 12 is a schematic view illustrating different stages in the phosphor layer formation steps.

### PREFERRED EMBODIMENTS FOR CARRYING OUT OF THE INVENTION

### 1. Basic Structure of PDP

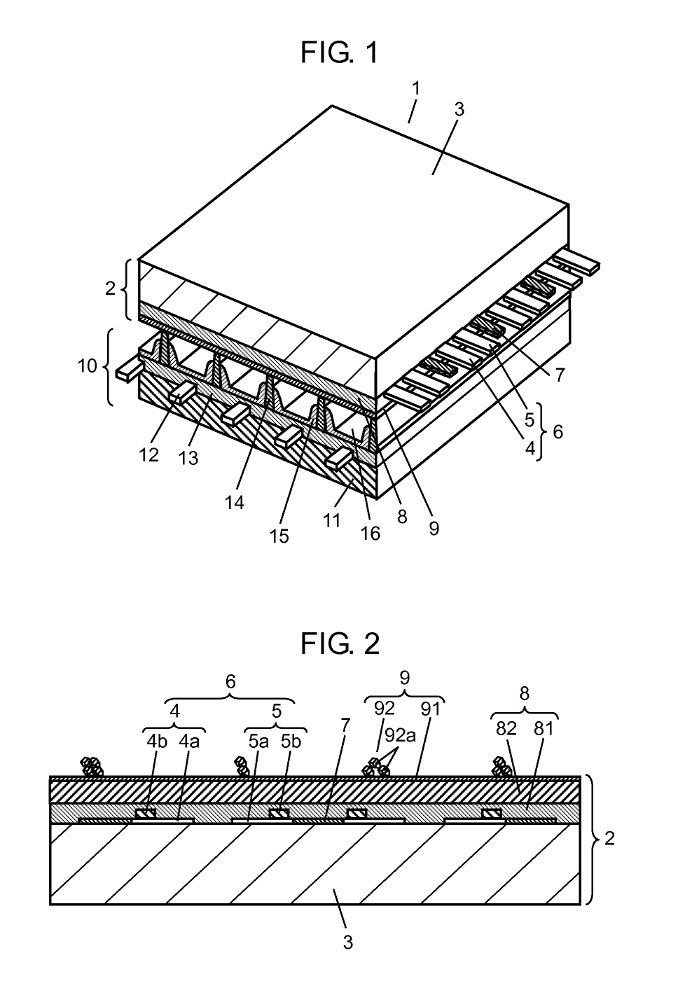

A basic structure of PDP is a general AC surface discharge PDP. As illustrated in FIG. 1, PDP 1 has a structure where front plate 2 including front glass substrate 3 and rear plate 10 including rear glass substrate 11 are disposed facing each other. Outer peripheral portions of front plate 2 and rear plate 10 are air-tightly sealed to each other by a sealing member made of, for example, glass frit. A discharge gas containing, for example, Ne and Xe is enclosed in discharge space 16 in PDP 1 formed by the sealed plates under a pressure in the range of 53 kPa (400 Torr) to 80 kPa (600 Torr).

A plurality of pairs of band-shape display electrodes 6 each including scan electrode 4 and sustain electrode 5 and a plurality of black stripes 7 are provided on front glass substrate 3 in parallel with each other. Dielectric layer 8 functioning as a capacitor is formed on front glass substrate 3 so as to cover display electrodes 6 and black stripes 7. A surface of dielectric layer 8 is coated with protective layer 9 made of, for example, MgO.

Scan electrodes 4 and sustain electrodes 5 are transparent electrodes made of an electrically conductive metallic oxide such as indium tin oxide (ITO), tin dioxide (SnO₂), or zinc oxide (ZnO) on which bus electrodes containing Ag are formed.

A plurality of data electrodes 12 made of an electrically conductive material containing silver (Ag) as its principal ingredient are formed on rear glass substrate 11 in parallel with each other in a direction orthogonal to display electrodes 6. Data electrodes 12 are coated with base dielectric layer 13. Barrier ribs 14 are formed to a predetermined height on base dielectric layer 13 between data electrodes 12 to divide discharge space 16. Phosphor layers are sequentially formed on base dielectric layer 13 and side surfaces of barrier ribs 14 for each of data electrodes 12, and the phosphor layers are respectively; phosphor layer 15 which emits red light, phosphor layer 15 which emits green light, and phosphor layer 15 which emits blue light, each layer emitting light in response to ultraviolet light. A discharge cell is formed at a position where display electrode 6 and data electrode 12 intersect with each other. The discharge cells respectively having red, green, and blue phosphor layers 15 arranged in the direction of display electrodes 6 constitute color display pixels.

In the present embodiment, the discharge gas enclosed in discharge space 16 includes Xe by no less than 10 vol. % and no more than 30 vol. %.

### 2. PDP Production Method

Next, a method for producing PDP 1 is described.

First, a method for producing front plate 2 is described. Scan electrodes 4, sustain electrodes 5, and black stripes 7 are formed on front glass substrate 3 by photolithography. Scan electrodes 4 and sustain electrodes 5 have bus electrodes 4b and 5b including Ag to ensure an electrical conductivity. Scan electrodes 4 and sustain electrodes 5 include transparent electrodes 4a and 5a. Bus electrodes 4b are provided on transparent electrodes 4a, and bus electrodes 5b are provided on transparent electrodes 5a.

A material such as ITO is used to form transparent electrodes 4a and 5a to ensure a degree of transparency and an electrical conductivity. First, an ITO thin film is formed on front glass substrate 3 by sputtering, and transparent electrodes 4a and 5a are then formed in a predetermined pattern by lithography.

A material used to form bus electrodes 4b and 5b is, for example, a white paste containing a glass frit, a photosensitive resin, and a solvent to increase an Ag—Ag binding capacity. First, the white paste is spread on front glass substrate 3 by screen printing, and the solvent in the white paste is removed in a baking oven. Next, the while paste is exposed to light via a photo mask formed in a predetermined pattern.

Then, the white paste is developed so that a bus electrode pattern is formed. Lastly, the bus electrode pattern is fired in a baking oven at a predetermined temperature so that the photosensitive resin in the bus electrode pattern is removed. Further, the glass frit in the bus electrode pattern is melted as the bus electrode pattern is fired, and the melted glass frit starts to vitrify again after the firing is over. As a result of these steps, bus electrodes 4b and 5b are formed.

Black stripes 7 are formed from a material including a black pigment. Then, dielectric layer 8 is formed. A material used to form dielectric layer 8 is, for example, a dielectric paste including a dielectric glass frit, a resin, and a solvent. First, the dielectric paste is spread in a predetermined thickness on front glass substrate 3 by die coating so as to cover scan electrodes 4, sustain electrodes 5, and black stripes 7. Next, the solvent in the dielectric paste is removed in a baking oven. Lastly, the dielectric paste is fired in a baking oven at a predetermined temperature so that the resin in the dielectric paste is removed. Further, the dielectric glass frit is melted as the dielectric paste is fired, and the melted dielectric glass frit starts to vitrify again after the firing is over. As a result of these steps, dielectric layer 8 is formed. In place of die coating employed to apply the dielectric paste, screen printing or spin coating may be employed. Instead of using the dielectric paste, a film used as dielectric layer 8 may be formed by CVD (Chemical Vapor Deposition). Dielectric layer 8 will be described in detail later.

Next, protective layer 9 is formed on dielectric layer 8. Details of protective layer 9 will be given later.

As a result of the steps described so far, scan electrodes 4, sustain electrodes 5, black stripes 7, dielectric layer 8, and protective layer 9 are formed on front glass substrate 3, and the production of front plate 2 is completed.

Next, a method for producing rear plate 10 is described. Data electrodes 12 are formed on rear glass substrate 11 by photolithography. A material used to form data electrodes 12 is, for example, a data electrode paste containing a glass frit, a photosensitive resin, and a solvent to increase an Ag—Ag binding capacity for ensuring an electrical conductivity. First, the data electrode paste is spread in a predetermined thickness on rear glass substrate 11 by screen printing, and the solvent in the data electrode paste is removed in a baking oven. Then, the data electrode paste is exposed to light via a photo mask formed in a predetermined pattern. Then, the data electrode paste is developed so that a data electrode pattern is formed. Lastly, the data electrode pattern is fired in a baking oven at a predetermined temperature so that the photosensitive resin in the data electrode pattern is removed. Further, the glass frit in the data electrode pattern is melted as the data electrode pattern is fired, and the melted glass frit starts to vitrify again after the firing is over. As a result of these steps, data electrodes 12 are formed. In place of screen printing employed to apply the data electrode paste, sputtering or vapor deposition may be employed.

Then, base dielectric layer 13 is formed. A material used to form base dielectric layer 13 is, for example, a base dielectric paste containing a dielectric glass frit, a resin, and a solvent. First, the base dielectric paste is spread in a predetermined thickness by screen printing on rear glass substrate 11 having data electrodes 12 formed thereon so as to cover data electrodes 12. Then, the solvent in the base dielectric paste is removed in a baking oven. Lastly, the base dielectric paste is fired at a predetermined temperature in a baking oven so that the resin in the base dielectric paste is removed. Further, the dielectric glass frit is melted as the base dielectric paste is fired, and the melted glass frit starts to vitrify again after the firing is over. As a result of these steps, base dielectric layer 13 is formed. In place of screen printing employed to apply the base dielectric paste, die coating or spin coating may be employed. Instead of using the base dielectric paste, a film used as base dielectric layer 13 may be formed by, for example, CVD.

Next, barrier ribs 14 are formed by photolithography. A material used to form barrier ribs 14 is, for example, a barrier rib paste containing a filler, a glass frit as a filler binding agent, a photosensitive resin, and a solvent. The barrier rib paste is spread on base dielectric layer 13 in a predetermined thickness by die coating. Then, the solvent in the barrier rib paste is removed in a baking oven, and the barrier rib paste is exposed to light via a photo mask formed in a predetermined pattern. The barrier rib paste is then developed so that a barrier rib pattern is formed. Lastly, the barrier rib pattern is fired at a predetermined temperature in a baking oven so that the photosensitive resin in the barrier rib pattern is removed. Further, the glass frit in the barrier rib pattern is melted as the barrier rib pattern is fired, and the melted glass frit starts to vitrify again after the firing is over. As a result of these steps, barrier ribs 14 are formed. The photolithography may be replaced with sandblasting.

Next, phosphor layers 15 are formed. A material used to form phosphor layers 15 is, for example, phosphor paste 19 including phosphor particles 17, a binder, and a solvent. Phosphor paste 19 according to the present embodiment further includes particles of a platinum group element. First, phosphor paste 19 is spread by dispensing in a predetermined thickness on base dielectric layer 13 between adjacent barrier ribs 14 and side surfaces of barrier ribs 14. Then, the solvent in phosphor paste 19 is removed in a baking oven. Lastly, phosphor paste 19 is fired at a predetermined temperature in a baking oven so that the resin in phosphor paste 19 is removed. As a result of these steps, phosphor layers 15 are formed. The dispensing may be replaced with screen printing or inkjetting. Phosphor layers 15 will be described in detail later.

As a result of the steps described so far, the production of rear plate 10 provided with the required structural elements on rear glass substrate 11 is completed.

Then, front plate 2 and rear plate 10 are assembled. A sealing member (not illustrated in the drawings) is formed in a peripheral portion of rear plate 10 by dispensing. A material of the sealing member (not illustrated in the drawings) is a sealing paste containing a glass frit, a binder, and a solvent. The solvent in the sealing paste is removed in a baking oven. Next, front plate 2 and rear plate 10 are disposed facing each other so that display electrodes 6 and data electrodes 12 are orthogonal to each other. Then, peripheral portions of front plate 2 and rear plate 10 are sealed by a glass frit. Lastly, the discharge gas containing Ne and Xe is enclosed in discharge space 16, and the production of PDP 1 is completed.

### 3. Detailed Description of the Embodiment

The embodiment is described in detail. As illustrated in FIG. 2, a plurality of pairs of band-shape display electrodes 6 each including scan electrode 4 and sustain electrode 5 and a plurality of black stripes 7 are provided on front glass substrate 3 in parallel with each other. Dielectric layer 8 is formed on front glass substrate 3 so as to cover display electrodes 6 and black stripes 7. A surface of dielectric layer 8 is coated with protective layer 9. Protective layer 9 includes base film 91 which is a base layer provided on dielectric layer 8 and agglomerated particles 92 which adhere to base film 91.

As illustrated in FIG. 10 described later, a plurality of data electrodes 12 are formed on rear glass substrate 11 in parallel with each other in a direction orthogonal to display electrodes 6. Data electrodes 12 are coated with base dielectric layer 13. Barrier ribs 14 are formed on base dielectric layer 13 between data electrodes 12. Phosphor layers 15 are formed on base dielectric layer 13 and side surfaces of barrier ribs 14. Platinum-group particles 18, which are particles of a platinum group element, adhere to phosphor layers 15.

### [3-1. Detailed Description of Dielectric Layer]

Dielectric layer 8 is described in detail. First dielectric layer 81 and second dielectric layer 82 constitute dielectric layer 8. Second dielectric layer 82 is provided on first dielectric layer 81.

A dielectric material of first dielectric layer 81 includes the following components; bismuth trioxide (Bi₂O₃) by 20 wt. % to 40 wt. %, at least one selected from a group consisting of calcium oxide (CaO), strontium oxide (SrO), and barium oxide (BaO) by 0.5 wt. % to 12 wt. %, and at least one selected from a group consisting of molybdenum trioxide (MoO₃), tungsten trioxide (WO₃), cerium dioxide (CeO₂), and manganese dioxide (MnO₂) by 0.1 wt. % to 7 wt. %.

In place of the group consisting of MoO₃, WO₃, CeO₂, and MnO₂, at least one selected from a group consisting of copper oxide (CuO), dichrome trioxide (Cr₂O₃), cobalt trioxide (Co₂O₃), divanadium heptoxide (V₂O₇), and diantimony trioxide (Sb₂O₃) may be included by 0.1 wt. % to 7 wt. %.

Other than the foregoing components, any of the following components not including lead may be included; ZnO by 0 wt. % to 40 wt. %, diboron trioxide (B₂O₃) by 0 wt. % to 35 wt. %, silicon dioxide (SiO₂) by 0 wt. % to 15 wt. %, and aluminum trioxide (Al₂O₃) by 0 wt. % to 10 wt. %.

To produce the powderized dielectric material, the dielectric material is ground by a wet jet mill or a ball mill so that an average particle diameter is 0.5 μm to 2.5 μm. When the powderized dielectric material by 55 wt. % to 70 wt. % and a binder component by 30 wt. % to 45 wt. % are kneaded well by a three-roll mill, a paste for first dielectric layer for die coating or printing is obtained.

The binder component is ethyl cellulose, or terpineol or butyl carbitol acetate including acrylic resin by 1 wt. % to 20 wt. %. If necessary, dioctyl phthalate, dibutyl phthalate, triphenyl phosphate, or tributyl phosphate may be further added to the paste as a plasticizer, and glycerol mono-oleate, sorbitan sesquioleate, HOMOGENOL (product supplied by Kao Corporation), alkylaryl phosphate, or the like may be further added to the paste as a dispersant. The addition of the dispersant improves a level of printability.

The paste for first dielectric layer is printed on front glass substrate 3 by die coating or screen printing so as to cover display electrodes 6. The paste for first dielectric layer thus printed is dried and then fired at 575° C. to 590° C. slightly higher than the softening point of the dielectric material so that first dielectric layer 81 is formed.

Next, second dielectric layer 82 is described. A dielectric material of second dielectric layer 82 includes the following components; Bi₂O₃ by 11 wt. % to 20 wt. %, at least one selected from a group consisting of CaO, SrO, and BaO by 1.6 wt. % to 21 wt. %, and at least one selected from a group consisting of MoO₃, WO₃, and CeO₂ by 0.1 wt. % to 7 wt. %.

In place of MoO₃, WO₃, and CeO₂, at least one selected from a group consisting of CuO, Cr₂O₃, Co₂O₃, V₂O₇, Sb₂O₃, and MnO₂ may be included by 0.1 wt. % to 7 wt. %.

Other than the foregoing components, any of the following components not including lead may be included; ZnO by 0 wt. % to 40 wt. %, B₂O₃ by 0 wt. % to 35 wt. %, SiO₂ by 0 wt. % to 15 wt. %, and Al₂O₃ by 0 wt. % to 10 wt. %.

To produce the powderized dielectric material, the dielectric material is ground by a wet jet mill or a ball mill so that an average particle diameter is 0.5 μm to 2.5 μm. When the powderized dielectric material by 55 wt. % to 70 wt. % and a binder component 30 wt. % to 45 wt. % are kneaded well by a three-roll mill, a paste for second dielectric layer applied by die coating or printing is obtained.

The binder component is ethyl cellulose, or terpineol or butyl carbitol acetate including acrylic resin by 1 wt. % to 20 wt. %. If necessary, dioctyl phthalate, dibutyl phthalate, triphenyl phosphate, or tributyl phosphate may be further added to the paste as a plasticizer, and glycerol mono-oleate, sorbitan sesquioleate, HOMOGENOL (product supplied by Kao Corporation), alkylaryl phosphate, or the like may be further added to the paste as a dispersant. The addition of the dispersant improves a level of printability.

The paste for second dielectric layer is printed on first dielectric layer 81 by die coating or screen printing. The paste for second dielectric layer thus printed is dried and then fired at 550° C. to 590° C. slightly higher than the softening point of the dielectric material so that second dielectric layer 82 is formed.

To ensure a good transmission factor of visible light, dielectric layer 8 preferably has a film thickness no more than 41 μm with first dielectric layer 81 and second dielectric layer 82 altogether.

To control a reaction of bus electrodes 4b and 5b with Ag, a larger volume of Bi₂O₃ is included in first dielectric layer 81 than Bi₂O₃ included in second dielectric layer 82, more specifically, Bi₂O₃ is included in first dielectric layer 81 by 20 wt. % to 40 wt. %. This decreases the visible light transmission factor of first dielectric layer 81 to be lower than that of second dielectric layer 82. Therefore, first dielectric layer 81 is formed in a smaller film thickness than second dielectric layer 82.

When Bi₂O₃ is included in second dielectric layer 82 by less than 11 wt. %, the possibility of color staining is reduced, however, air bubbles are more easily generated in second dielectric layer 82. Therefore, it is not preferable to include Bi₂O₃ by less than 11 wt. %. The content of Bi₂O₃ by more than 40 wt. % increases the possibility of color staining, deteriorating the visible light transmission factor. Therefore, it is not preferable to include Bi₂O₃ by more than 40 wt. %.

As the film thickness of dielectric layer 8 is smaller, such effects as improvement of a luminance level and reduction of a discharge voltage become more prominent. Therefore, it is desirable to make the film thickness of dielectric layer 8 as small as possible to such an extent that a breakdown voltage thereof is not thereby deteriorated.

In view of these technical aspects, the film thickness of dielectric layer 8 according to the present embodiment is no more than 41 μm, wherein first dielectric layer 81 has the film thickness of 5 μm to 15 μm, and second dielectric layer 82 has the thickness of 20 μm to 36 μm.

It was confirmed that PDP 1 thus produced can control the color staining (turning yellow) of front glass substrate 3 and air bubbles generated in dielectric layer 8 regardless of Ag used in display electrodes 6, thereby significantly improving the breakdown voltage of dielectric layer 8.

Below is discussed why these dielectric materials can prevent first dielectric layer 81 from turning yellow and control the generation of air bubbles therein in PDP 1 according to the present embodiment. It is already known that such compounds as Ag₂MoO₄, Ag₂Mo₂O₇, Ag₂Mo₄O₁₃, Ag₂WO₄, Ag₂W₂O₇, and Ag₂W₄O₁₃ are more easily generated at low temperatures no more than 580° C. by adding MoO₃ or WO₃ to dielectric glass containing Bi₂O₃. According to the present embodiment wherein the firing temperature of dielectric layer 8 is 550° C. to 590° C., silver ions (Ag⁺) diffused in dielectric layer 8 during firing react with MoO₃, WO₃, CeO₂, and MnO₂ in dielectric layer 8 and generate stable compounds, thereby stabilizing Ag⁺. Thus, the stabilization can be accomplished without the reduction of Ag⁺, and such an unfavorable event is avoidable that Ag⁺ starts to agglomerate, generating colloids. The stabilization of Ag⁺ lessens oxygen generated by the collidization of Ag, thereby lessening air bubbles generated in dielectric layer 8.

To further improve these effects, MoO₃, WO₃, CeO₂, or MnO₂ is preferably included in the dielectric glass containing Bi₂O₃ by no less than 0.1 wt. %, and more preferably by no less than 0.1 wt. % and no more than 7 wt. % because the turning-yellow event is not very effectively prevented from happening if less than 0.1 wt. %, and the glass is unfavorably color-stained if more than 7 wt. %.

As described so far, dielectric layer 8 of PDP 1 according to the present embodiment is technically advantageous in that first electric layer 81 made of Ag and contacting bus electrodes 4b and 5b controls turning yellow and the generation of air bubbles therein, and second dielectric layer 82 provided on first dielectric layer 81 helps to accomplish a high light transmission factor. As a result, a PDP provided with dielectric layer 8 having such remarkable layers can prevent turning yellow, control the generation of air bubbles, and achieve a good light transmission factor.

### [3-2. Details of Protective Layer]

Protective layer 9 includes base film 91 which is a base layer and agglomerated particles 92. Base film 91 includes at least a first metallic oxide and a second metallic oxide. The first metallic oxide and the second metallic oxide are two selected from a group consisting of MgO, CaO, SrO, and BaO. Base film 91 further has at least a peak through an X-ray diffraction analysis. The peak is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of base film 91.

[3-2-1. Details of Base Film]

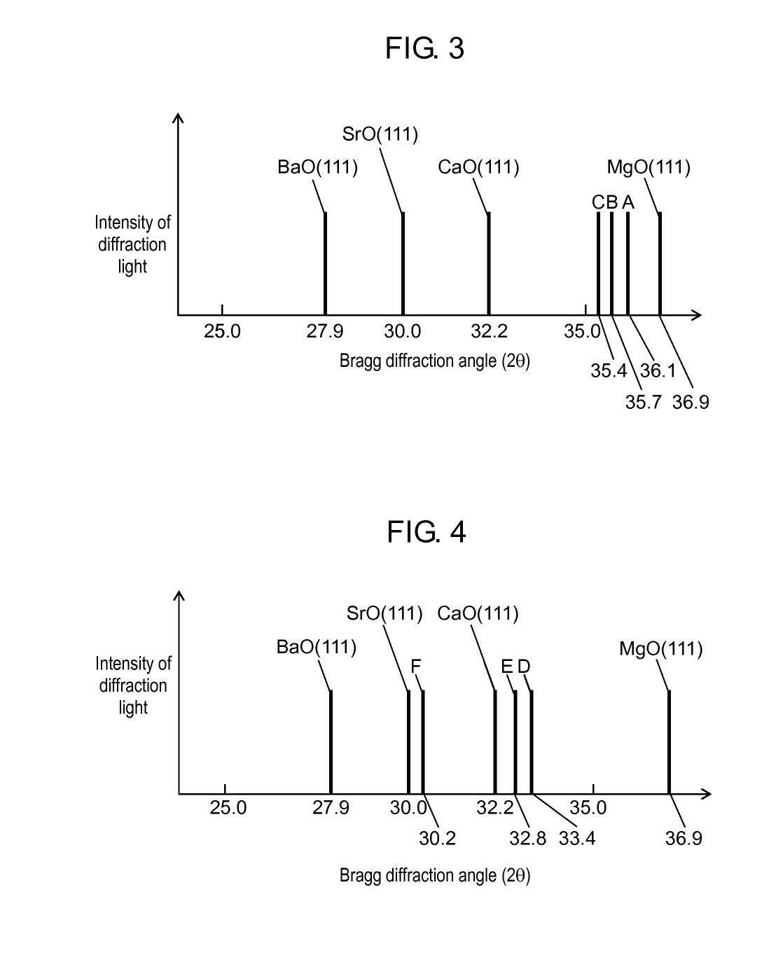

FIG. 3 illustrates X-ray diffraction analysis results obtained from the surface of base film 91 constituting protective layer 9 of PDP 1 according to the present embodiment. FIG. 3 further illustrates X-ray diffraction analysis results when MgO, CaO, SrO, and BaO are each singly used.

In FIG. 3, a lateral axis represents the Bragg diffraction angle (28), and a longitudinal axis represents the strength of an X-ray diffracted wave. The diffraction angle is expressed by 360 degrees in full circle, and the strength is expressed by an arbitrary unit. A crystalline orientation plane, which is a specific orientation plane, is bracketed.

As illustrated in FIG. 3, CaO used as a single component in the plane orientation of (111) has a peak at the diffraction angle of 32.2 degrees. MgO used as a single component has a peak at the diffraction angle of 36.9 degrees. SrO used as a single component has a peak at the diffraction angle of 30.0 degrees. BaO used as a single component has a peak at the diffraction angle of 27.9 degrees.

In PDP 1 according to the present embodiment, base film 91 of protective layer 9 includes at least two metallic oxides selected from a group consisting of MgO, CaO, SrO, and BaO.

FIG. 3 illustrates X-ray diffraction results in the case where two single components constitute base film 91. Point A shows the X-ray diffraction result of base film 91 in which MgO and CaO are each used as a single component. Point B shows the X-ray diffraction result of base film 91 in which MgO and SrO are each used as a single component. Point C shows the X-ray diffraction result of base film 91 in which MgO and BaO are each used as a single component.

As illustrated in FIG. 3, Point A has a peak at the diffraction angle of 36.1 degrees in the plane orientation of (111). MgO alone constituting the first metallic oxide has a peak at the diffraction angle of 36.9 degrees. CaO alone constituting the second metallic oxide has a peak at the diffraction angle of 32.2 degrees. Therefore, the peak of Point A is present between the peak of MgO and CaO each used as a single component. Similarly, Point B has a peak at the diffraction angle of 35.7 degrees, and Point B is present between the peak of MgO constituting the first metallic oxide and SrO constituting the second metallic oxide each used as a single component. Point C has a peak at the diffraction angle of 35.4 degrees, and Point C is present between the peak of MgO constituting the first metallic oxide and BaO constituting the second metallic oxide each used as a single component.

FIG. 4 illustrates X-ray diffraction results in the case where no less than three single components constitute base film 91. Point D shows the X-ray diffraction result of base film 91 in which MgO, CaO, and SrO are each used as a single component. Point E shows the X-ray diffraction result of base film 91 in which MgO, CaO and BaO are each used as a single component. Point F shows the X-ray diffraction result of base film 91 in which CaO, SrO, and BaO are each used as a single component.

As illustrated in FIG. 4, Point D has a peak at the diffraction angle of 33.4 degrees in the plane orientation of (111). MgO alone constituting the first metallic oxide has a peak at the diffraction angle of 36.9 degrees. SrO alone constituting the second metallic oxide has a peak at the diffraction angle of 30.0 degrees. Therefore, the peak of Point A is present between the peak of MgO and CaO each used as a single component. Similarly, Point E has a peak at the diffraction angle of 32.8 degrees, and Point E is present between the peak of MgO constituting the first metallic oxide and BaO constituting the second metallic oxide each used as a single component. Point F has a peak at the diffraction angle of 30.2 degrees, and Point F is present between the peak of MgO constituting the first metallic oxide and BaO constituting the second metallic oxide each used as a single component.

Therefore, base film 91 of PDP 1 according to the present embodiment includes at least the first metallic oxide and the second metallic oxide. Base film 91 has at least a peak in the X-ray diffraction analysis. The peak is present between the first peak in the X-ray diffraction analysis of the first metallic oxide and the second peak in the X-ray diffraction analysis of the second metallic oxide. The first peak and the second peak indicate the plane orientation equal to the plane orientation indicated by the peak of base film 91. The first metallic oxide and the second metallic oxide are two selected from a group consisting of MgO, CaO, SrO, and BaO.

In the description given so far, (111) is used as an example of the crystal plane orientation. In any other plane orientation, the peaks of the metallic oxides are similarly positioned.

Depths of CaO, SrO, and BaO based on a vacuum level are present in a relatively shallow region as compared to MgO. This is a probable cause of increase of electrons released by the Auger effect as compared to transition from the energy level of MgO when electrons present at energy levels of CaO, SrO, and BaO transit to the ground state of Xe ions to drive PDP 1.

As described earlier, the peak of base film 91 according to the present embodiment is present between the peak of the first metallic oxide and the peak of the second metallic oxide. Thus, the energy level of base film 91 is present between the metallic oxides each used as a single component. Therefore, electrons released by the Auger effect are likely to increase as compared to transition from the energy level of MgO.

Because of these facts, base film 91 can exert favorable secondary electron release characteristics as compared to MgO alone, thereby reducing a discharge sustain voltage. When the partial pressure of Xe used as the discharge gas is elevated especially to increase the luminance level, the discharge voltage can be reduced. As a result, PDP 1 can succeed in the voltage reduction and improvement of the luminance level.

Table 1 shows a discharge sustain voltage result when a mixed gas containing Xe and Ne (Xe by 15%) is enclosed under 450 Torr in PDP 1 according to the embodiment of the present invention in which the technical requirement of base film 91 is different.

TABLE 1

| | Sample | Sample | Sample | Sample | Sample | Comparative |
|---|---|---|---|---|---|---|
| | A | B | C | D | E | example |
| Discharge | 90 | 87 | 85 | 81 | 82 | 100 |
| sustain | | | | | | |
| voltage | | | | | | |
| (a.u.) | | | | | | |

The discharge sustain voltage of Table 1 is expressed by relative values based on the value of Comparative Example “100”. Base film 91 of Sample A includes MgO and CaO. Base film 91 of Sample B includes MgO and SrO. Base film 91 of Sample C includes MgO and BaO. Base film 91 of Sample D includes MgO, CaO, and SrO. Base film 91 of Sample E includes MgO, CaO, and BaO. Base film 91 of Comparative Example includes MgO alone.

When the partial pressure of the discharge gas Xe is increased from 10% to 15%, the luminance level is improved by approximately 30%. In Comparative Example in which base film 91 includes MgO alone, the discharge sustain voltage is elevated by approximately 10%.

In contrast, the PDP according to the embodiment of the present invention can reduce the discharge sustain voltage in any of Sample A, Sample B, Sample C, Sample D, and Sample E by approximately 10% to 20% as compared to Comparative Example. Therefore, voltages within the range of a normal operation can be used to start the electrical discharge, and the PDP can achieve a low-voltage drive and a higher luminance level.

Any of CaO, SrO, and BaO has a high degree of reactivity when singly used, therefore, they easily react with an impurity, deteriorating a degree of electron releasability. The embodiment of the present invention, however, lessens the reactivity by using the metallic oxides described so far, and provides a crystalline structure in which contamination with an impurity and oxygen deficiency are less likely. Therefore, it is prevented that electrons are overly released when the PDP is driven, and suitable electron retention characteristics can be accomplished as well as the other favorable effects which are the low-voltage drive and secondary electron releasability. The electron retention characteristics are advantageous in that wall charges stored in an initialization stage are retained to avoid any address error in a address period so that a address discharge is reliably exercised.

[3-2-2. Details of Agglomerated Particles]

Next, agglomerated particles 92 provided on base film 91 according to the embodiment of the present invention are described in detail.

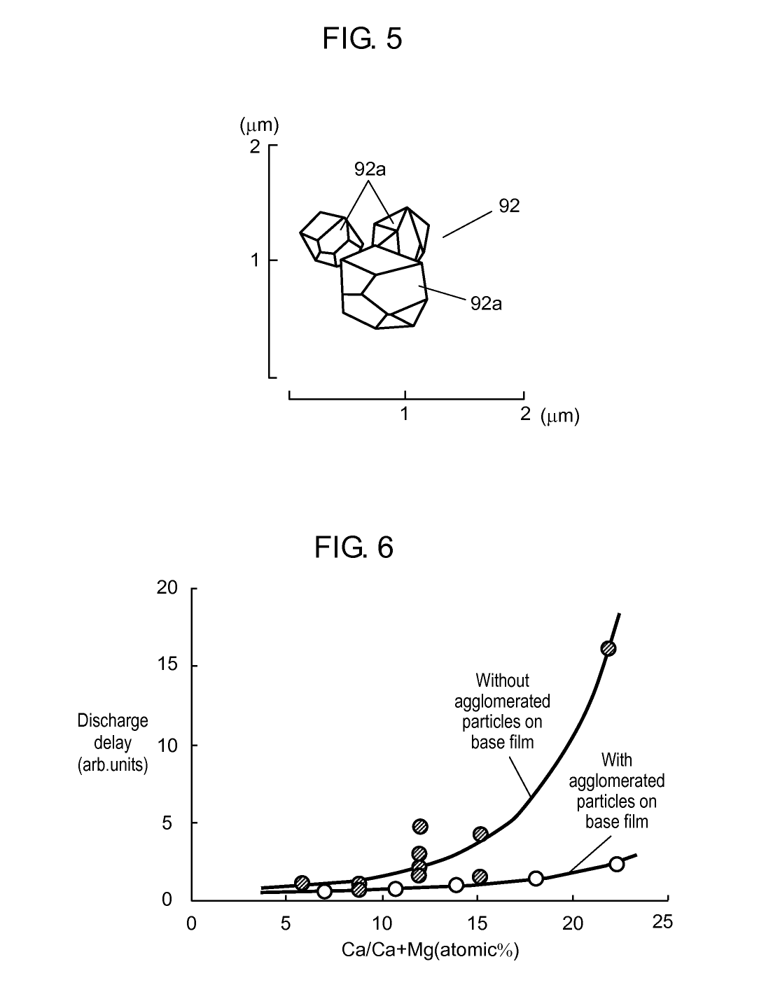

As illustrated in FIG. 5, a plurality of MgO crystal particles 92a agglomerated to one another constitutes agglomerated particle 92. The shape of agglomerated particle 92 can be confirmed by a scan electronic microscope (SEM). According to the present embodiment, agglomerated particles 92 are dispersed evenly on the entire surface of base layer 91.

Crystal particles 92a each has an average particle diameter in the range of 0.9 μm to 2 μm. The average particle diameter recited in the present embodiment is a volume cumulative diameter (D50). To measure the average particle diameter, a particle size distribution measuring apparatus of laser diffraction type MT-3300 (supplied by NIKKISO CO., LTD.) was used.

In agglomerated particles 92, crystal particles 92a are not bonded to one another by a strong binding force as a solid matter. Agglomerated particle 92 are each an assembly of primary particles gathered by static electricity or van der Waals force. More specifically, crystal particles 92a are bound by such an external force, for example, supersonic wave, that all or a part of agglomerated particle 92 is disassembled into primary particles. Agglomerated particles 92 have particle diameters of approximately 1 μm. Crystal particle 92a has a polygonal shape having at least seven surfaces such as cuboctahedron or dodecahedron. Crystal particle 92a can be produced by vapor phase synthesis or precursor firing technique described below. In the vapor phase synthesis, a magnesium (Mg) metallic material having a purity no less than 99.9% is heated in an atmosphere filled with an inactive gas, and a small amount of oxygen is added in an atmosphere for further heating, so that Mg is directly oxidized. Thus, MgO crystal particles 92a are obtained. In the precursor firing technique, crystal particles 92a are obtained by the following technique. In precursor firing technique, an MgO precursor is evenly fired at such a high temperature as no less than 700° C. and then slowly cooled down so that MgO crystal particles 92a are obtained. The precursor is, for example, at least a compound selected from magnesium alkoxide (Mg(OR)₂), magnesium acetyl acetone (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂), and magnesium oxalate (MgC₂O₄). Some of the selected compounds may take the form of hydrate, which can also be used. The selected compound is adjusted so that the purity of MgO after the firing is no less than 99.95%, desirably no less than 99.98%. In the case where at least a certain amount of impurity elements, such as alkali metals, B, Si, Fe, or Al is included in the selected compound, unnecessary inter-particle cohesion or sintering occurs during the heat process, making it difficult to obtain highly crystalline crystal particles 92a made of MgO. Therefore, it is necessary to adjust the precursor in advance by removing such an impurity element. The firing temperature or firing atmosphere in the precursor firing technique is adjusted so that the particle diameters are adjusted. The firing temperature is selected from the temperature range of approximately 700° C. to 1,500° C. The firing temperature no less than 1,000° C. can control the primary particle diameters to 0.3 to 2 μm. Crystal particles 92a are obtained in the formation process using a liquid phase process in the form of agglomerated particles 92 in which the primary particles are agglomerated to one another.

It was confirmed in the tests conducted by the inventors of the present invention that MgO agglomerated particles 92 control a discharge delay mostly in the address discharge and improve a temperature dependency of the discharge delay. The present embodiment, therefore, provides agglomerated particles 92 as an initial electron supplier necessary for a discharge pulse to rise because agglomerated particles 92 are more highly capable of releasing initial electrons than base film 91.

A main likely cause of the discharge delay is an insufficient amount of initial electrons as a trigger released from the surface of base film 91 into discharge space 16 in an initial stage of the electric discharge. For constant supply of the initial electrons to be released into discharge space 16, MgO agglomerated particles 92 are dispersed evenly on the surface of base film 91. This supplies sufficient electrons into discharge space 16 when the discharge pulse rises, avoiding the discharge delay. As a result of such initial electron release characteristics, PDP 1 having an improved definition can achieve a fast drive while attaining an improved discharge responsiveness. When agglomerated particles 92 of the metallic oxide are thus provided on the surface of base film 91, the discharge delay mostly in the address discharge is effectively controlled, and the temperature dependency of the discharge delay can be lessened.

As described so far, PDP 1 according to the present embodiment includes base film 91 which accomplishes a low-voltage drive and a good charge retainability both and MgO agglomerated particles 92 which effectively prevent a discharge delay. This technical advantage enables PDP 1 with a higher definition to be driven fast with a low voltage and to display images with a high quality while avoiding any lighting failure.

[3-2-3. Test 1]

FIG. 6 is a graph illustrating a relationship between a discharge delay and a calcium (Ca) concentration in protective layer 9 in the case where base film 91 including MgO and CaO is used in PDP 1 according to the embodiment of the present invention. Base film 91 includes MgO and CaO and has a peak between a diffraction angle at which the peak of MgO is generated and a diffraction angle at which the peak of CaO is generated through an X-ray diffraction analysis.

FIG. 6 illustrates an example in which base film 91 alone is used as protective layer 9 and an example in which agglomerated particles 92 are provided on base film 91, and base film 91 not including Ca is used as a reference to evaluate the discharge delay.

It is clear from FIG. 6 illustrating the example in which base film 91 alone is used and the example in which agglomerated particles 92 are provided on base film 91 that the discharge delay increases as the Ca concentration is elevated in the example in which base film 91 alone is used, whereas the discharge delay is largely reduced, and the discharge delay hardly increases regardless of the elevated Ca concentration in the example in which agglomerated particles 92 are provided on base film 91.

[3-2-4. Test 2 ]

Next, results of tests conducted to confirm the effects of PDP 1 having protective layer 9 according to the present embodiment are described.

PDPs 1 having protective layers 9 differently formed were produced as samples. Sample 1 is PDP 1 having MgO protective layer 9 alone. Sample 2 is PDP 1 having MgO protective layer 9 doped with such an impurity as Al or Si. Sample 3 is PDP 1 in which the primary particles alone of MgO crystal particles 92a are dispersed on and adhere to MgO protective layer 9.

Sample 4 is PDP 1 according to the embodiment of the present invention. Sample 4 is PDP 1 in which agglomerated particles 92 including MgO crystal particles 92a having equal particle diameters agglomerate to one another adhere evenly to all over the surface of base film 91 made of MgO. Sample A described earlier is used as protective layer 9. Protective layer 9 has base film 91 including MgO and CaO and agglomerated particle 92 including crystal particles 92a which are agglomerated to one another and adhere evenly to all over the surface of base film 91. Base film 91 has a peak between the peak of the first metallic oxide and the peak of the second metallic oxide constituting base film 91 in the X-ray diffraction analysis of the surface of base film 91. In other words, the first metallic oxide is MgO, and the second metallic oxide is CaO. The diffraction angle of the peak of MgO is 36.9 degrees, the diffraction angle of the peak of CaO is 32.2 degrees, and the diffraction angle of the peak of base film 91 is 36.1 degrees.

The electron releasability and charge retainability were measured in these PDPs 1 respectively having four different protective layers.

As a numerical value of the electron releasability is larger, more electrons are released. The electron releasability is expressed in the form of an initial electron release amount determined by a discharge surface condition, type of gas, and condition of gas. The initial electron release amount can be measured by measuring an electron current amount released from the surface when ion or electronic beam is irradiated thereon, however, it is difficult to perform the measurement in a non-destructive approach. Therefore, the method disclosed in Unexamined Japanese Patent Publication No. 2007-48733 was used. Of delay times during the electric discharge, a numerical value as an indicator of a degree of dischargeability, called a statistical delay time, was measured. When an inverse number of the statistical delay time is integrated, a numerical value linearly corresponding to the initial electron release amount is obtained. The discharge delay time is a delay time of the address discharge from the rise of the address discharge pulse. A main likely cause of the discharge delay is that there is some difficulty in the release of the initial electrons which trigger the address discharge from the protective layer surface into the discharge space.

An indicator used to evaluate the charge retainability is a voltage value (hereinafter, called Vscn lighting voltage) applied to the scan electrodes necessary to control the charge release when PDP 1 is produced. As the Vscn lighting voltage is lower, the charge retainability is higher because the PDP can be driven with a lower voltage as the Vscn lighting voltage is lower. Because of this advantage, any parts having a lower breakdown voltage and a smaller capacity can be used as a power supply and electric components. Among the products currently available, devices having a breakdown voltage of approximately 150 V are conventionally used as a semiconductor switching element such as MOSFET used for sequential application of the scan voltage to a plate. The Vscn lighting voltage is desirably no more than 120 V in view of temperature-dependent variability.

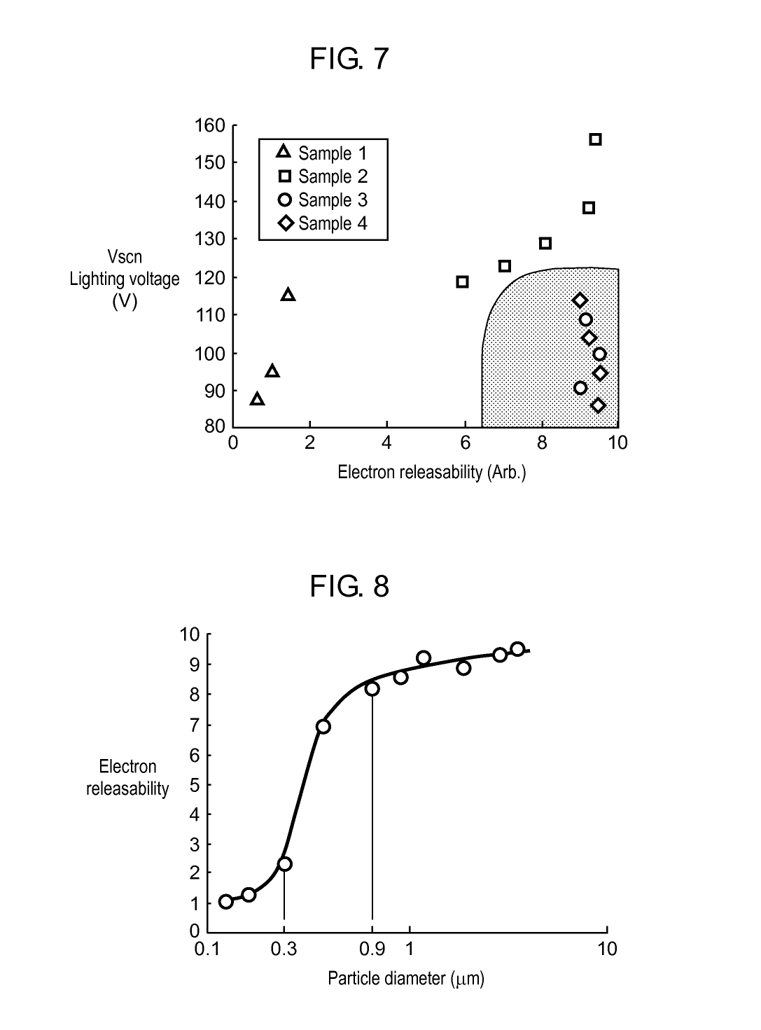

FIG. 7 illustrates results of the electron releasability and charge retainability measured in the PDPs 1. When the electron releasability shows a larger numerical value, more electrons are released. The electron releasability is expressed in the form of an initial electron release amount determined by a discharge surface condition, type of gas, and condition of gas. The initial electron release amount can be measured by measuring an electron current amount released from the surface when ion or electronic beam is irradiated thereon, however, it is difficult to perform the measurement in a non-destructive approach for evaluation of the surface of front plate 2 of PDP 1. Therefore, the method disclosed in Unexamined Japanese Patent Publication No. 2007-48733 was used. Of delay times during the electric discharge, a numerical value as an indicator of a degree of dischargeability, called a statistical delay time, was measured. When an inverse number of the statistical delay time is integrated, a numerical value linearly corresponding to the initial electron release amount is obtained.

This numerical value is used for the evaluation. The discharge delay time is a delay time of the discharge from the rise of the pulse. A main likely cause of the discharge delay is that there is some difficulty in the release of the initial electrons as a trigger from the surface of protective layer 9 into the discharge space in an initial stage of the electric discharge.

An indicator used to evaluate the charge retainability is a voltage value (hereinafter, called Vscn lighting voltage) applied to the scan electrodes necessary to control the charge release when PDP 1 is produced. As the Vscn lighting voltage is lower, the charge retainability is higher. Because of this advantage, any parts having a lower breakdown voltage and a smaller capacity can be used as a power supply and electric components in designing PDP 1. Among the products currently available, devices having a breakdown voltage of approximately 150 V are conventionally used as a semiconductor switching element such as MOSFET used for sequential application of the scan voltage to a plate. The Vscn lighting voltage is desirably no more than 120 V in view of temperature-dependent variability.

As is clear from FIG. 7, Sample 4 succeeded in reducing the Vscn lighting voltage to no more than 120 V in the evaluation of the charge retainability, and further succeeded in achieving significantly improved characteristics as compared to the electron releasability of Sample 1 in which MgO is the only material of the protective layer.

In general, the electron releasability and the charge retainability of the protective layer in PDP contradict with each other. When, for example, deposition conditions of the protective layer are changed or the protective layer is doped with an impurity such as Al, Si, or Ba to form film, the electron releasability can be improved. This, however, brings an adverse effect, which is increase of the Vscn lighting voltage.

The PDP having protective layer 9 according to the present embodiment can attain the electron releasability no less than 8 and the charge retainability that the Vscn lighting voltage is no more than 120 V. More specifically, protective layer 9 thus obtained has the electron releasability and the charge retainability which are good enough for any PDP wherein there are more scan lines to meet the demand of a higher definition and a cell size is increasingly reduced.

[3-2-5. Test 3]

Below is described in detail the particle diameter of the crystal particles used in protective layer 9 of PDP 1 according to the embodiment of the present invention. The particle diameter recited in the following description is an average particle diameter, and the average particle diameter is a volume cumulative diameter (D50).

FIG. 8 illustrates a test result of the electron releasability checked by changing the average particle diameter of MgO agglomerated particles 92 in protective layer 9. Referring to FIG. 8, agglomerated particles 92 were observed by SEM so that the average particle diameter thereof was measured.

As illustrated in FIG. 8, the electron releasability declines when the average particle diameter is as small as approximately 0.3 μm. As far as the average particle diameter is no less than approximately 0.9 μm, the electron releasability of an expected level can be obtained.

To increase the number of electrons released in the discharge cell, number of crystal particles per unit area of protective layer 9 is desirably larger. It was learnt from the tests conducted by the inventors of the present invention that the top portions of barrier ribs 14 may be broken in the case where crystal particles 92a are present on or near barrier ribs 14 in close contact with protective layer 9, in which case the material of broken barrier ribs 14 might drop on the phosphors, possibly failing to light on or off any relevant cell normally. Such an unfavorable event as the breakage of the barrier rib is unlikely to occur as far as crystal particles 92a are not present at the top portions of the barrier ribs, meaning that the chances of the breakage of barrier ribs 14 are higher as more crystal particles adhere to the layer. This technical problem was studied, and it was learnt that the probability of the barrier rib breakage soars when the crystal particle diameter is as large as approximately 2.5 μm, while the probability of the barrier rib breakage is relatively small as far as the crystal particle diameter is smaller than 2.5 μm.

As described, PDP 1 having protective layer 9 according to the present embodiment can gain the electron releasability no less than 8 and the charge retainability that the Vscn lighting voltage is no more than 120 V.

The crystal particles described in the embodiment of the present invention are MgO particles. A similar effect can be exerted by other single crystal particles, for example, crystal particles obtained from a metallic oxide capable of a high electron releasability similarly to MgO such as Sr, Ca, Ba, or Al. Therefore, the particles are not necessarily limited to MgO.

[3-2-6. Protective Layer Production Method]

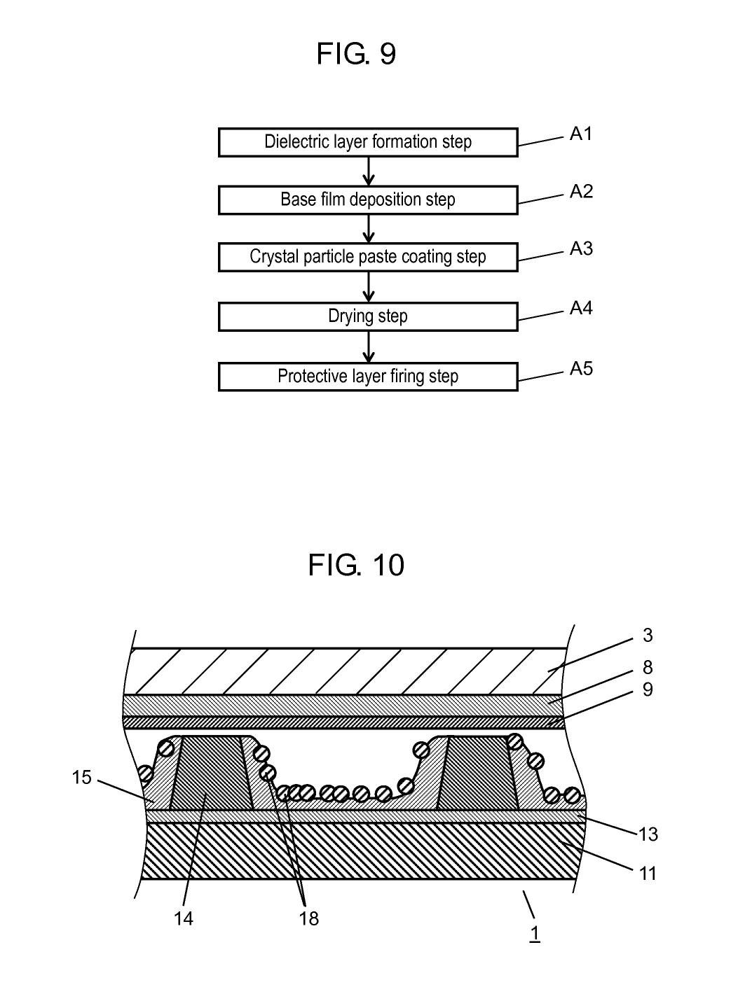

Next, production steps of forming protective layer 9 in PDP 1 according to the present embodiment are described referring to FIG. 9.

As illustrated in FIG. 9, in base film deposition step A2 subsequent to dielectric layer formation step A1 in which dielectric layer 8 is formed, base film 91 including at least two selected from a group of consisting of MgO, CaO, SrO, and BaO is formed on dielectric layer 8 by vacuum deposition. A raw material used in vacuum deposition is a pellet in which MgO alone, CaO alone, SrO alone, or BaO alone is used, or a pellet in which these materials are mixed. Other than the vacuum deposition, electron beam deposition, sputtering, or ion plating may be employed.

Then, agglomerated particles 92 are scattered on base film 91 still unfired and adhere thereto. Agglomerated particles 92 are dispersed evenly on the entire surface of base film 91.

To start with in this step, polygonal crystal particles 92a having a predetermined particle diameter distribution are mixed with a solvent so that an agglomerated particle paste is prepared. Then, in agglomerated particle paste coating step A3, base film 91 is coated with the agglomerated particle paste so that an agglomerated particle paste film having an average film thickness of 8 μm to 20 μm is formed. The agglomerated particle paste is spread on base film 91 by screen printing, spraying, spin coating, die coating, or slit coating.

The solvent used in the production of the agglomerated particle paste preferably has a good affinity with MgO base film 91 and agglomerated particles 92, and has a vapor pressure of approximately several ten Pa at normal temperature to facilitate the removal of vapor in drying step A4 that follows. Examples of the solvent are an organic solvent in which methyl methoxy butanol, terpineol, propylene glycol, or benzyl alcohol is dissolved as a single component, or a solvent in which these substances are mixed. The paste containing the solvent thus obtained has a viscosity in the range of several mPa·s to several ten mPa·s.

The substrate coated with the agglomerated particle paste is immediately transferred to drying step A4. Drying step A4 dries the agglomerated particle paste under a reduced pressure. More specifically, the agglomerated particle paste is dried rapidly within several ten seconds in a vacuum chamber so that in-plane convection, which is a notable phenomenon in heat dry, does not occur. Therefore, agglomerated particles 92 adhere more evenly to base film 91. In drying step A4, heat dry may be employed depending on the type of solvent used to produce the mixed crystal particle paste.

In protective layer firing step A5, unfired base film 91 formed in base film deposition step A2 and the agglomerated particle paste film after drying step A4 is over are both fired at the same time at a temperature of several hundred degrees. The firing removes the solvent and resin component remaining in the agglomerated particle paste film. As a result, protective layer 9 to which agglomerated particles 92 including polygonal crystal particles 92a adhere is formed on base film 91.

According to the production method, agglomerated particles 92 can be dispersed evenly on the entire surface of base film 91.

Other than the foregoing method, in place of using the solvent, the particles and a gas may be directly sprayed or the particles may be dispersed by gravity.

In the description given so far, MgO is used as the material of protective layer 9. However, the requirement to be met in base film 91 is absolutely high sputtering resistance to protect dielectric layer 8 from the impact of ions, therefore, it is not necessary for the charge retainability or the electron releasability of base film 91 to be so high. In the conventional PDPs, the protective layer containing MgO as its principal ingredient is often used to achieve at least a certain level of charge retainability and sputtering resistance both. However, MgO is not the only option of the material because the electron releasability is dominantly controlled by the metallic oxide single crystal particles. There are other materials superior in shock resistance that can be used as the material, for example, Al₂O₃.

The present embodiment was described based on the MgO single crystal particles. However, a similar effect can be exerted by other single crystal particles, for example, crystal particles obtained from a metallic oxide capable of a high electron releasability similarly to MgO such as Sr, Ca, Ba, or Al. Therefore, the particles are not necessarily limited to MgO.

### [3-3. Details of Phosphor Layer]

As illustrated in FIG. 10, platinum group particles 18 adhere onto phosphor layers 15 according to the present embodiment. To form phosphor layers 15, phosphor paste 19 including phosphor particles 17, a resin, and a solvent is used. Phosphor paste 19 according to the present embodiment includes platinum group particles 18. Platinum group particles 18 according to the present embodiment are made of palladium (Pd). Other usable materials except palladium are platinum group elements such as platinum (Pt), rhodium (Rh), ruthenium (Ru), iridium (Ir), and osmium (Os). Besides, nickel (Ni) and the like may be used. Though the material of platinum group particles 18 according to the present embodiment is palladium (Pd), any of platinum, rhodium, ruthenium, iridium, osmium, and nickel, or a mixture of at least two of these substances may be used in place of using palladium. Platinum group particles 18 preferably have an average particle diameter smaller than that of phosphor particles 17. The average particle diameter is a volume cumulative diameter (D50). When the solvent in phosphor paste 19 is removed therefrom, platinum group particles 18 having the average particle diameter no more than that of phosphor particles 17 can easily transfer to the surface-layer side of phosphor layers 15. The average particle diameter of platinum group particles 18 is desirably no less than ½ and no more than 1/10 of the average particle diameter of phosphor particles 17. This is because platinum group particle 18 can more easily transfer. The average particle diameter of platinum group particles 18 is more desirably no less than 0.3 μm and no more than 1 μm, meaning that the average particle diameter of phosphor particles 17 is desirably no less than 2 μm and no more than 3 μm. Platinum group particles 18 having the average particle diameter smaller than 0.3 μm are more likely to agglomerate to one another in phosphor paste 19. Platinum group particles 18 are more likely to sink in phosphor paste 19 in the case where the average particle diameter of phosphor particle 17 exceeds 3 μm. The present embodiment uses platinum group particles 18 having the average particle diameter of no less than 0.3 μm and no more than 1 μm and phosphor particles 17 having the average particle diameter of no less than 2 μm and no more than 3 μm.

The solvent of phosphor paste 19 desirably has a better adhesion to platinum group particles 18 than to phosphor particles 17. When the solvent thus has a better adhesion to platinum group particles 18 than to phosphor particles 17, platinum group particles 18 are likely to transfer to an upper side of phosphor layers 15 when the solvent is removed. A coating rate by which phosphor layers 15 are coated with platinum group particles 18 is desirably no more than 50%, and more desirably no less than 1% and no more than 10% to prevent platinum group particles 18 from blocking the light emission from the phosphor layers. The coating rate according to the present embodiment is 5%.

The coating rate is the expression by percentage of a value obtained by dividing an area a where platinum group particles 18 adhere in a discharge cell region by an area b of a discharge cell; coating rate (%)=a/b×100. To measure the coating rate, for example, a region corresponding to a discharge cell divided by barrier ribs 14 is photographed by a camera, the obtained image is trimmed into the size of an x×y cell, the trimmed image is binarized into white and black image data, the area a of a black region where platinum group particles 18 adhere is obtained based on the binarized data, and the coating rate is then calculated from the formula a/b×100.

When platinum group particles 18 thus adhere onto phosphor layers 15, the charge retainability of base film 19 is further improved. Another advantage of platinum group particles 18 is to be able to control the characteristics variability of base film 91 during a long-term use of PDP 1. These advantages are obtained probably because water molecules (H₂O) or carbon dioxide (CO₂) present in discharge space 16 are lessened by platinum group particles 18 which adhere to phosphor layers 15.

It is illustrated in FIG. 2 that platinum group particles 18 adhere onto all over phosphor layers 15 in a scattering manner. Platinum group particles 18 should adhere to at least a part of the surfaces of phosphor layers 15. Platinum group particles 18 may be dispersed in phosphor layers 15. In the case where platinum group particles 18 are dispersed in phosphor layers 15, such an unfavorable event that platinum group particles 18 block the light emission of the phosphor layers can be prevented from happening. However, the charge retainability of base film 91 is improved when platinum group particles 18 adhere to an upper side of phosphor layers 15.

### [3-4. Phosphor Layer Production Method]

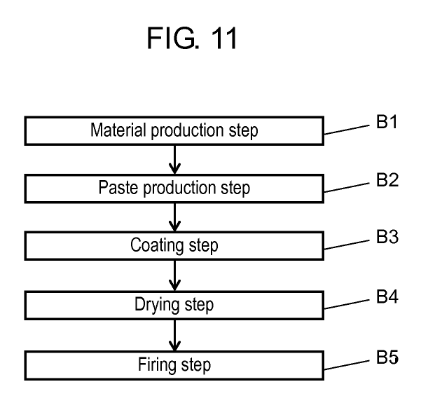

Next, production steps of producing phosphor layers 15 in PDP 1 according to the present embodiment are described referring to FIG. 11.

First, material production step B1 illustrated in FIG. 11 is described. To form phosphor layer 15, powderized phosphor particles 17, powderized platinum group particles 18, a resin, and a solvent are used. Phosphor particles 17 include phosphor particles 17 having an average particle diameter of no less than 2 μm and no more than 3 μm and respectively emitting red, blue, and green light. (Y, Gd)BO₃:Eu is used for the red phosphor particles, Zn₂SiO₄:Mn is used for the green phosphor particles, and BaMgAl₁₀O₁₇:Eu is used for the blue phosphor particles. The material of platinum group particles 18 is palladium, ethyl cellulose is used as the resin, and a solvent in which butyl carbitol acetate and terpineol are mixed is used as the solvent. If necessary, a plasticizer or a dispersant may be further added. The materials of the phosphor particles, resin, and solvent are not necessarily limited to the given examples, and the following substances are further usable; for the phosphor particles, YBO₃:Eu₃₊ or Y(P,V)O₄:Eu₃₊ for the red phosphor particles, BaAl₁₂O₁₉:Mn or YBO₃:Tb for the green phosphor particles, and Y₂SiO₅:Ce, (Ca,Sr,Ba)₁₉(PO₄)₆Cl₂:Eu₂₊, or (Zn,Cd)S:Ag for the blue phosphor particles, hydroxypropyl cellulose, polyvinyl alcohol, or acrylic resin for the resin, and diethylene glycol, methyl ether, or multivalent alcohol derivative for the solvent.

A method for synthesizing powderized phosphor particles 17 is described. The materials are weighed and mixed well, and then put in a heat-resistant container such as a crucible. The materials put in the container are fired in the atmosphere or in a reduced atmosphere. The fired materials are ground by a wet jet mill or ball mill so that an average particle diameter is 0.5 μm to 2.5 μm. As a result, powderized phosphor particles 17 are obtained.

A method for producing powderized platinum group particles 18 is described. There are six examples of the platinum group element, Pt, Pd, Rh, Ru, Ir, and Os, among which Pd is most stably used because it is inexpensive and has a stable absorbability. The powderized Pd is produced by, for example, the following wet reduction so that their particle diameters stay within the foregoing range as compared to the particle diameters of the phosphor particles. To obtain the powderized Pd, a Pd compound solution is reduced by a reducer so that the powderized Pd is precipitated. As the Pd compound, tetraamine palladium (II) salt such as tetraamine palladium chlorite is used. As the reducer, a hydrazine compound such as hydrazine sulfate is used. When these materials are used, powderized Pd in which grains are spherical and equally sized can be deposited.

Paste production step B2 is described. Powderized phosphor particles 17 of red, blue, and green colors are weighed. Powderized phosphor particles 17 of the respective colors, powderized platinum group particles 18, a resin, and a solvent are weighed so as to obtain a predetermined viscosity. The viscosity is desirably no less than 0.01 Pa·s and 100 Pa·s, and more desirably no less than 5 Pa·s and no less than 50 Pa·s so that the paste can be ejected evenly through a nozzle of a dispenser. The materials thus weighed and mixed are kneaded by a three-roll mill so that phosphor paste 19 of each color is obtained. The concentration of phosphor particles 17 in the phosphor paste is preferably no less than 20 wt. % and 60 wt. %. The concentration of platinum group particles 18 in the phosphor paste is preferably no less than 0.1 wt. % and no more than 10 wt. %. The concentration of phosphor particles 17 according to the present embodiment in the phosphor paste is 40 wt. %. The concentration of platinum group particles 18 according to the present embodiment in the phosphor paste is 1 wt. %.

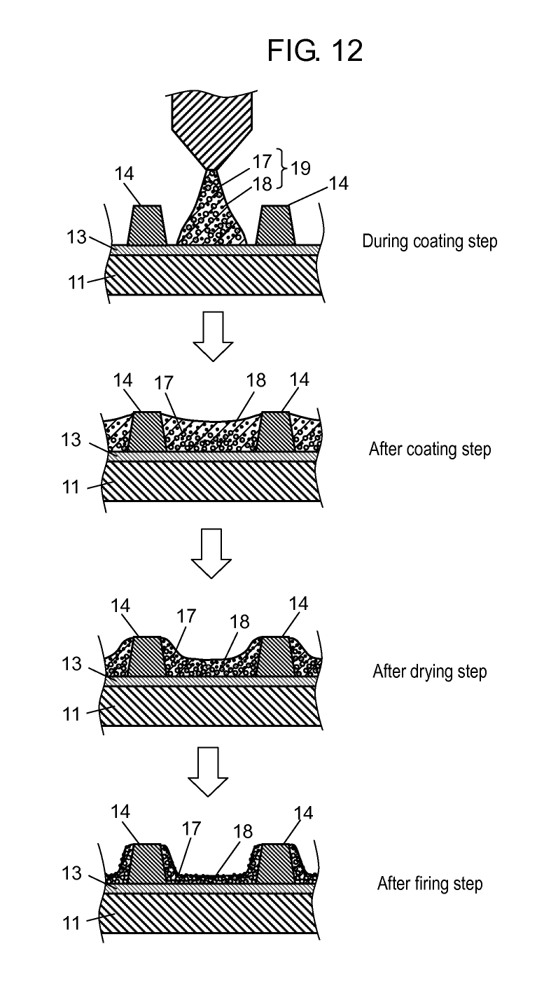

Next, coating step B3 is described. Phosphor paste 19 produced in paste production step B2 is put in the dispenser. Then, as illustrated in FIG. 12, phosphor paste 19 is spread in a predetermined thickness on base dielectric layer 13 between adjacent barrier ribs 14 and side surfaces of barrier ribs 14. In place of the dispensing, screen printing or inkjetting, for example, may be employed.

Next, drying step B4 is described. The substrate coated with phosphor pastes 19 in coating step B3 is immediately transferred to a baking oven. The solvent in phosphor pastes 19 is removed in the baking oven. Drying Step B4 dries the films of phosphor pastes 19 under a reduced pressure. More specifically, phosphor pastes 19 are speedily dried within several ten seconds in a vacuum chamber, in which case convection, which is a notable phenomenon in heat dry, does not occur in phosphor pastes 19. When the solvent is removed, platinum group particles 18 are transferred to the surface because a binding strength between the solvent and platinum group particles 18 is larger than a binding strength between the solvent and phosphor particles 17. Therefore, phosphor particles 17 and platinum group particles 18 adhere more evenly to the side surfaces of barrier ribs 14 and the surface of base dielectric layer 13. Further, platinum group particles 18 adhere to the surfaces of the dried phosphor pastes as illustrated in FIG. 12. As a drying method employed in drying step B4, heat dry may be employed depending on what solvent is used in the production of phosphor pastes 19.

Lastly, firing step B5 is described. The substrate to which phosphor pastes 19 dried in drying step B4 adhere is transferred to a baking oven. In firing step B5, the substrate is fired in the baking oven at a temperature of several hundred degrees. The firing removes the solvent and resin remaining in the phosphor pastes. As a result, phosphor layers 15 including layers of phosphor particles 17 and platinum group particles 18 are formed. Platinum group particles 18 adhere to an upper portion of the layers of phosphor particles 17 as illustrated in FIG. 12.

As a result of the steps described so far, phosphor layers 15 are formed. These steps can make platinum group particles 18 adhere to the surfaces of phosphor layers 15.

Other processes available are; spraying platinum group particles 18 and a gas directly to phosphor layers 15 while masking barrier ribs 14, and dispersing platinum group particles 18 by gravity.

### 4. Conclusion

PDP 1 according to the present embodiment has front plate 2 and rear plate 10 disposed so as to face front plate 2. Front plate 2 includes dielectric layer 8 and protective layer 9 which covers dielectric layer 8. Rear plate 10 includes base dielectric layer 13, a plurality of barrier ribs 14 formed on base dielectric layer 13, and phosphor layers 15 formed on base dielectric layer 13 and side surfaces of barrier ribs 14. Protective layer 9 includes base film 91 which is a base layer formed on dielectric layer 8. Agglomerated particles 92 in which crystal particles of magnesium oxide are agglomerated to one another are dispersed evenly on an entire surface of base film 91. Base film 91 includes at least a first metallic oxide and a second metallic oxide. Base film 91 has at least a peak through an X-ray diffraction analysis. The peak is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of base film 91. The first metallic oxide and the second metallic oxide are two selected from a group consisting of MgO, CaO, SrO, and BaO. Phosphor layers 15 include platinum group particles 18 which are particles of a platinum group element.

As described so far, PDP 1 according to the present embodiment includes base film 91 which enables a low-voltage drive and a good charge retainability both and MgO agglomerated particles 92 which effectively prevent a discharge delay. This technical advantage enables PDP 1 with a higher definition to be driven fast with a low voltage and to display images with a high quality while avoiding any lighting failure. Further, PDP 1 according to the present embodiment includes platinum group particles 18 in phosphor layers 15, thereby improving the charge retainability of base film 91.

### INDUSTRIAL APPLICABILITY

The technology disclosed in the present embodiment is useful in realizing low power PDP having a display performance with a higher definition and a higher luminance.

### REFERENCE MARKS IN THE DRAWINGS

1 PDP
2 front plate
3 front glass substrate
4 scan electrode
4a, 5a transparent electrode
4b, 5b bus electrode
5 sustain electrode
6 display electrode
7 black stripe
8 dielectric layer
9 protective layer
10 rear plate
11 rear glass substrate
12 data electrode
13 base dielectric layer
14 barrier rib
15 phosphor layer
16 discharge space
17 phosphor particle
18 platinum group particle
19 phosphor paste
81 first dielectric layer
82 second dielectric layer
91 base film
92 agglomerated particle
92a crystal particle

1. A plasma display panel comprising:
a front plate; and
a rear plate disposed so as to face the front plate, wherein
the front plate includes a dielectric layer and a protective layer which covers the dielectric layer,
the rear plate includes a base dielectric layer, a plurality of barrier ribs formed on the base dielectric layer, and phosphor layers formed on the base dielectric layer and side surfaces of the barrier ribs,
the protective layer includes a base layer formed on the dielectric layer,
agglomerated particles in which crystal particles of magnesium oxide are agglomerated to one another are dispersed evenly on an entire surface of the base layer,
the base layer includes at least a first metallic oxide and a second metallic oxide, and has at least a peak through an X-ray diffraction analysis,
the peak is present at an intermediate position between a first peak through an X-ray diffraction analysis of the first metallic oxide and a second peak through an X-ray diffraction analysis of the second metallic oxide,
the first peak and the second peak indicate a plane orientation equal to a plane orientation indicated by the peak of the base layer,
the first metallic oxide and the second metallic oxide are two selected from a group consisting of magnesium oxide, calcium oxide, strontium oxide, and barium oxide, and
the phosphor layers include particles of a platinum group element.

2. The plasma display panel according to claim 1, wherein
the phosphor layers include a plurality of phosphor particles, and
an average particle diameter of the particles of the platinum group element is no more than an average particle diameter of the phosphor particles.

3. The plasma display panel according to claim 2, wherein
the average particle diameter of the particles of the platinum group element is no less than 1/10 and no more than ½ of the average particle diameter of the phosphor particles.

4. The plasma display panel according to claim 3, wherein
the average particle diameter of the particles of the platinum group element is no less than 0.3 μm and no more than 1 μm.

5. The plasma display panel according to claim 1, wherein
the particles of the platinum group element adhere to at least a part of surfaces of the phosphor layers.
